(19) United States
(12) Patent Application Publication
(10) Pub. No.: US 2012/0022926 A1
(43) Pub. Date: Jan. 26, 2012

(54) PROCESS FOR INCREASING VISIBILITY OF ANIMATED ADVERTISEMENTS

(76) Inventor: Kumaresan Ramanathan, Nashua, NH (US)

(21) Appl. No.: 13/249,266

(22) Filed: Sep. 30, 2011

Related U.S. Application Data
(63) Continuation-in-part of application No. 12/834,114, filed on Jul. 12, 2010.
(60) Provisional application No. 61/388,005, filed on Sep. 30, 2010.

(51) Int. Cl. G06Q 30/00

(52) U.S. Cl. 705/14.4; 705/14.43

(57) ABSTRACT

One embodiment of a process for improving visibility of an animated advertisement by playing the animation from the beginning when the advertisement becomes visible to the viewer. Advertisement animation is replayed by reloading the advertisement media from cache. Loading from the cache happens very quickly and it appears as though the animation has been replayed. Other embodiments are described and shown.

### CROSS-REFERENCE TO RELATED APPLICATIONS

This application claims the benefit of provisional patent application No. 61/388,005 filed Sep. 30, 2010 by the present inventor.

This application is a CIP of patent application Ser. No. 12/834,114 filed Jul. 12 2010 by the present inventor.

### COPYRIGHT

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND

The following is a list of some patent application references that presently appears relevant:

| | |
|---|---|
| 1 | United States Patent Application 20110231265 |
| | Kind Code A1 |
| | Brown; Darrick Paul; et al. Sep. 22, 2011 |
| 2 | United States Patent Application 20110208587 |
| | Kind Code A1 |
| | Grewal; Ranjit Singh; et al. Aug. 25, 2011 |

Many websites generate revenue from advertisements. The revenue generated from advertisements often depends on the extent to which users engage and interact with advertisements on the site. One way to measure user engagement is through the click-through-rate. The click-through-rate is the number of clicks an advertisement receives for a specific number of times that the advertisement is viewed. Usually the click-through-rate is expressed as a percentage.

When the click-through-rate on a site is high, advertisers are usually willing to pay higher rates to run their advertisements on that site. Conversely, a site with low click-through-rates usually earns less from advertisements.

One mechanism that has been used for increasing the click-through-rate is to show an animation in the advertisement. Animations attract attention from viewers and lead to higher engagement. Unfortunately, the current technology for playing animated advertisements on a web-page plays the animation as soon as the advertisement loads.

But an advertisement is not always visible to a user when the page loads. The advertisement might be lower down on the page so it becomes visible only after scrolling down. Or the advertisement might be in a tab that is currently not visible. Or the advertisement might be on a different window that is in the background. Or the advertisement might be in a minimized window. In such situations the advertisement is not visible to the user.

If an animated advertisement is not visible to the user when it is loaded onto a page, the animation will play without the user seeing the animation. Animations on advertisements typically run for 30 seconds and then stop. If the advertisement is not visible to the user in the first 30 seconds after the advertisement loads, the user will not see the animation. Instead the user will eventually see the still image that is displayed after the animation ends. If a user does not see the animation, then the likelihood that the user will notice the advertisement is lower. When users don't notice the advertisement, the click-through-rate is lower.

Another problem is that a part of the animation might have completed before the user sees the advertisement. For example, consider an animated advertisement at the bottom of a tall web-page. Since the web-page is tall, only the top portion of the web-page will be visible within the web-browser window when the page first loads. Suppose the animation in the advertisement plays for 30 seconds. If 15 seconds elapses before the user scrolls down to see the bottom of the page, then the user will see the animation after half of it has completed playing. This means that the advertiser's message will not be properly delivered to the user.

### SUMMARY

In accordance with one embodiment, a process for increasing visibility of animated advertisements comprises starting or restarting the animation when the advertisement becomes visible to the user.

In accordance with another embodiment, a process for increasing visibility of animated advertisements comprises polling the visibility of an advertisement, determining when the advertisement becomes visible to the user, and playing the animation from the beginning when the advertisement becomes visible to the user.

Accordingly several advantages of one or more aspects are as follows: To increase click-through rates for animated advertisements, to increase user recall of the brand message, to improve the return-on-investment for the advertiser, to increase revenue for the website publisher, to increase roll-overs and other user-engagement with animated advertisements.

Other advantages of one or more aspects will be apparent from a consideration of the drawings and ensuing description.

### DRAWINGS-FIGURES

FIG. 1 shows a web-page 1010 with a title, content 1020, and an animated advertisement 1030 at the bottom of the page.

FIG. 2 shows the top portion of the web-page 1010 visible within a web-browser's viewport 1040.

FIG. 3 shows the bottom portion of the web-page 1010 visible within the web-browser's viewport.

FIG. 4 shows a web-browser window 4010 that contains a URL address bar 4020 and a tab 4030 open to a web-page.

FIG. 5 shows the web-browser window 4010 after a second tab has been opened. The first tab 4030 is visible and the page within the second tab 4040 is not visible.

FIG. 6 shows the web-browser window 4010 with the second tab 4040 visible. The tab has a web-page that contains an animated advertisement 4050.

FIG. 7 shows a web-browser window 7010 with a URL address bar 7020 and a viewport 7030 that is displaying a web-page 7040.

FIG. 8 shows two web-browser windows. The first window 7010 is in the foreground. A second window 8010 with an address bar 8020 and viewport 8030 is in the back.

FIG. 9 shows the window 8010 in the foreground. An advertisement 8040 that had been hidden earlier is now visible. Window 7010 is in the back.

FIG. 10 shows a flowchart for playing animations.

FIG. 11 shows a schematic for a computerized system for displaying advertisements that play animations.

FIG. 12 Algorithm for playing animations

FIG. 13 Alternative algorithm

### DRAWINGS

### Reference Numerals

1010 Web-page
1020 Content in web-page
1030 Advertisement
1040 Web-browser viewport
4010 Web-browser window
4020 URL address bar
4030 First Tab—Tabbed panel that displays a web-page
4040 Second Tab—Another tabbed panel
4050 Advertisement
7010 Web-browser window
7020 URL address bar
7030 Viewport
7040 Web-page
8010 Web-browser window
8020 URL address bar
8030 Viewport
8040 Advertisement
10010 Step to check if advertisement is visible. Loop if it is visible. Exit loop when the advertisement is hidden.
10020 Step to check if advertisement is invisible. Loop if it is invisible. Exit loop when the advertisement becomes visible.
10030 Step to replay animation in advertisement
11010 World-Wide Web
11020 Computation Means
11030 Display Means
11040 Input/Output Means

### DETAILED DESCRIPTION

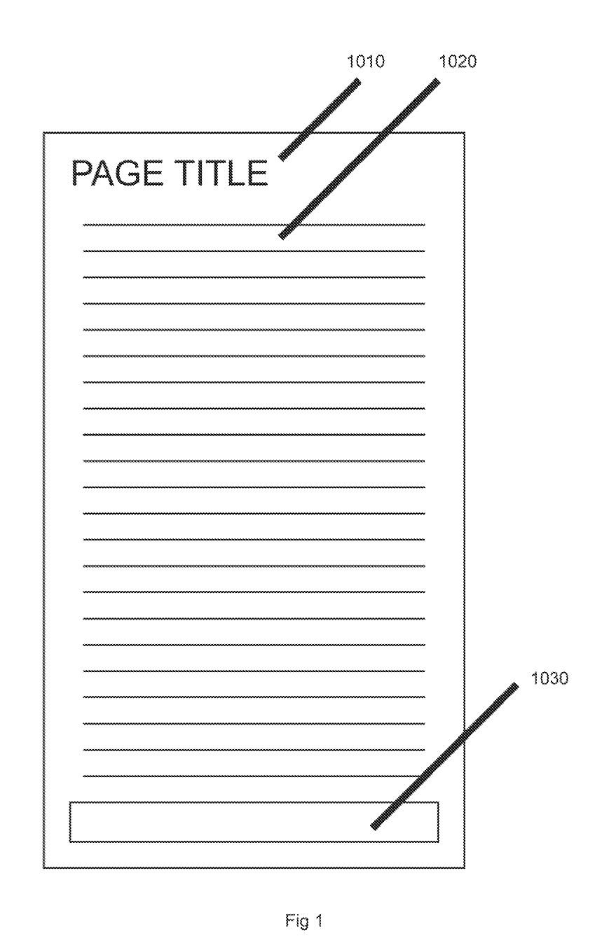

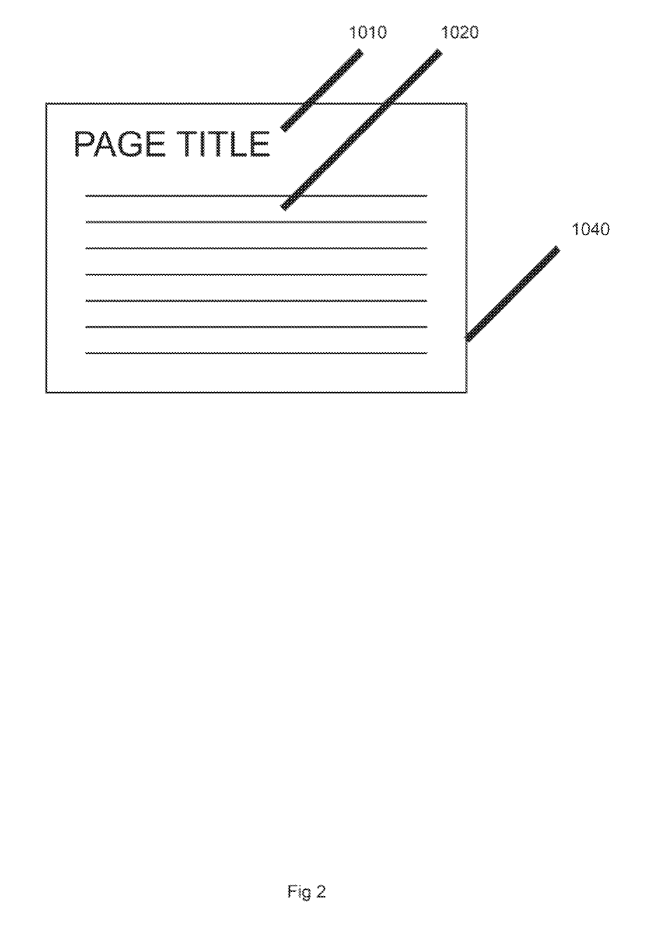

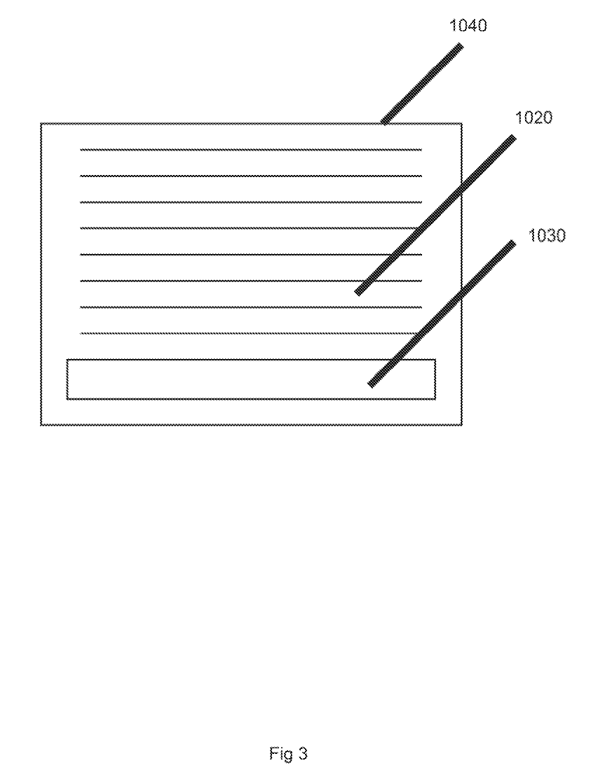

One embodiment is illustrated in FIG. 1, FIG. 2, and FIG. 3. FIG. 1 shows a web-page 1010 with a title, content 1020, and an advertisement 1030 at the bottom of the page. The page is taller than a typical web-browser window. So the entire page will not fit within a browser window. Only a portion of the web-page will be visible within the rendering area of the web-browser. The rendering area is also known as “viewport”. When the web-page first loads in the browser, only the top portion of the web-page 1010 is visible within a web-browser's viewport 1040 as shown in FIG. 2. At this time the advertisement and any animation that might be playing in the advertisement is not visible to the user.

After some time the user finishes reading the top portion of the page and scrolls down. FIG. 3 illustrates the situation after the user scrolls down. The web-browsers viewport is displaying the bottom portion of the web-page which includes the advertisement 1030.

When the user scrolls down, the advertisement comes into view within the browser window. When the animated advertisement becomes visible, the animation is played from the beginning.

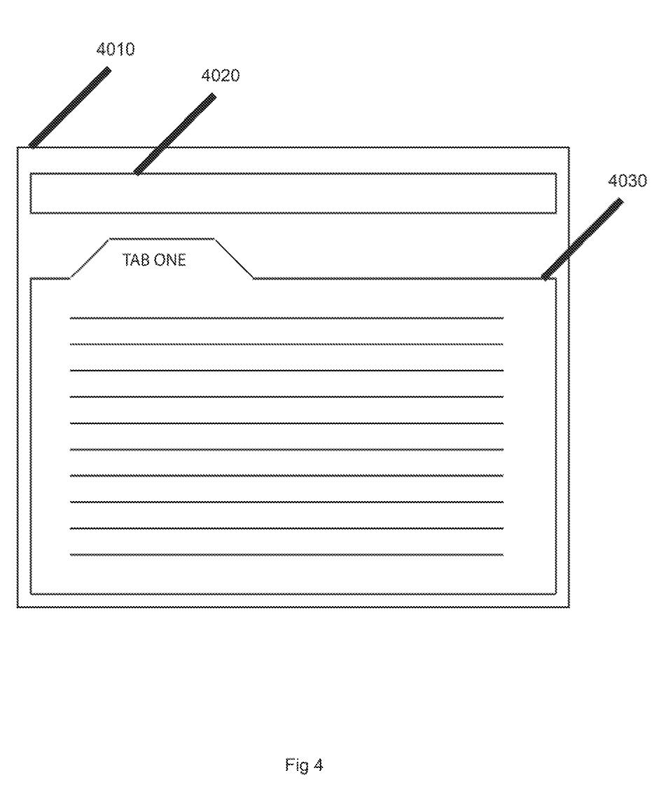

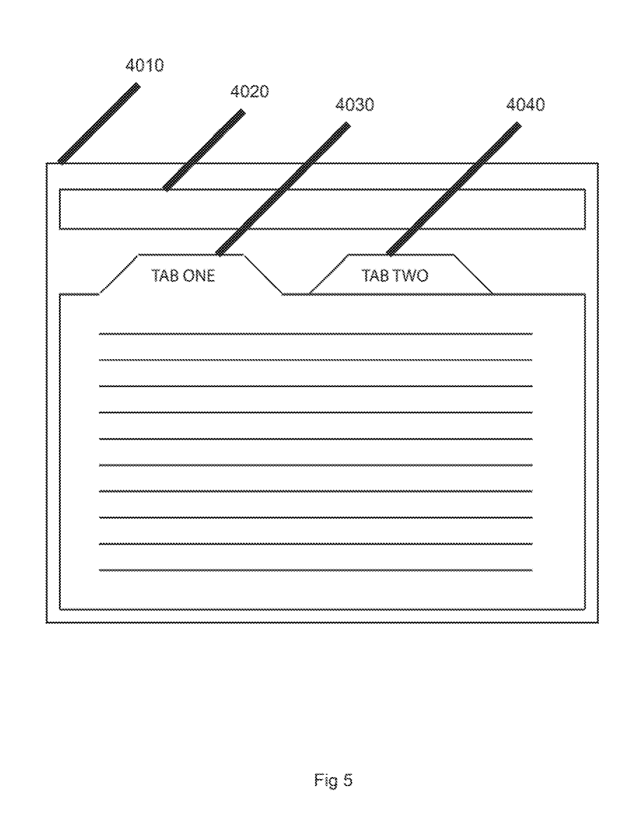

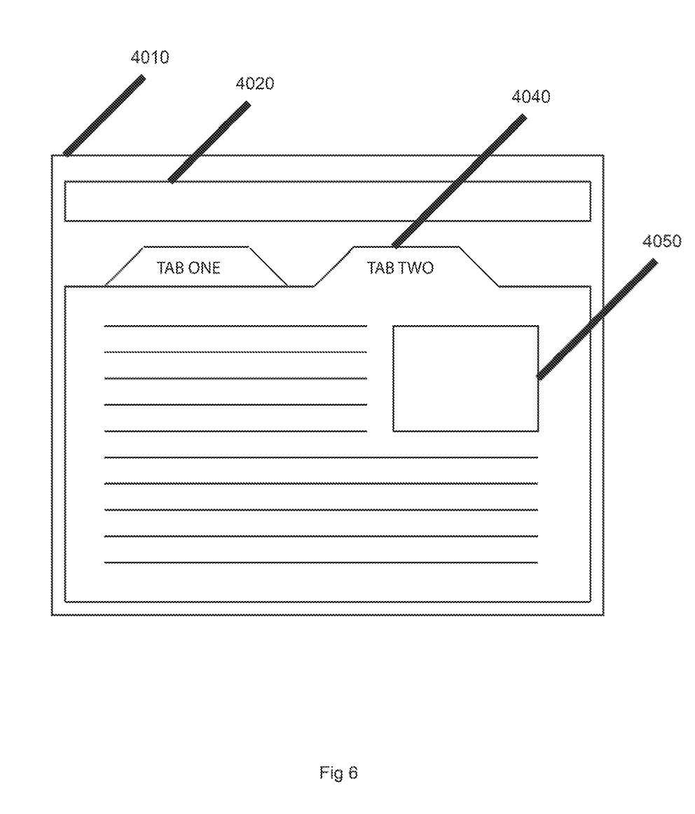

Another embodiment is described in FIG. 4, FIG. 5, and FIG. 6. FIG. 4 shows a web-browser window 4010 that contains a URL address bar 4020 and a tab 4030 open to a web-page. Suppose that a user browsing this page were to open another web-page in a different tab. The newly opened second tab would be invisible to the user until he/she switches to that tab. FIG. 5 shows the web-browser window 4010 that contains two tabs. The first tab 4030 is visible and the page within the second tab 4040 is not visible. If there is an advertisement inside the second tab 4040, it will not be visible to the user. If the animation finishes playing when user is not viewing the second tab, then the user will not see the animation.

If the user subsequently switches to the second tab, then the advertisement 4050 becomes visible as shown in FIG. 6. At this point, the animation of the advertisement is played from the beginning so that the user gets a chance to view the entire animation.

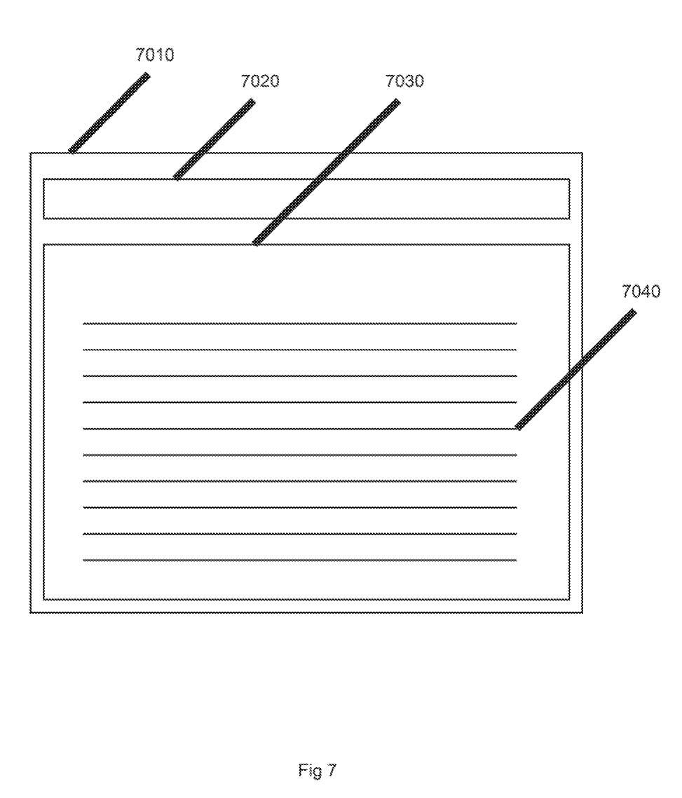

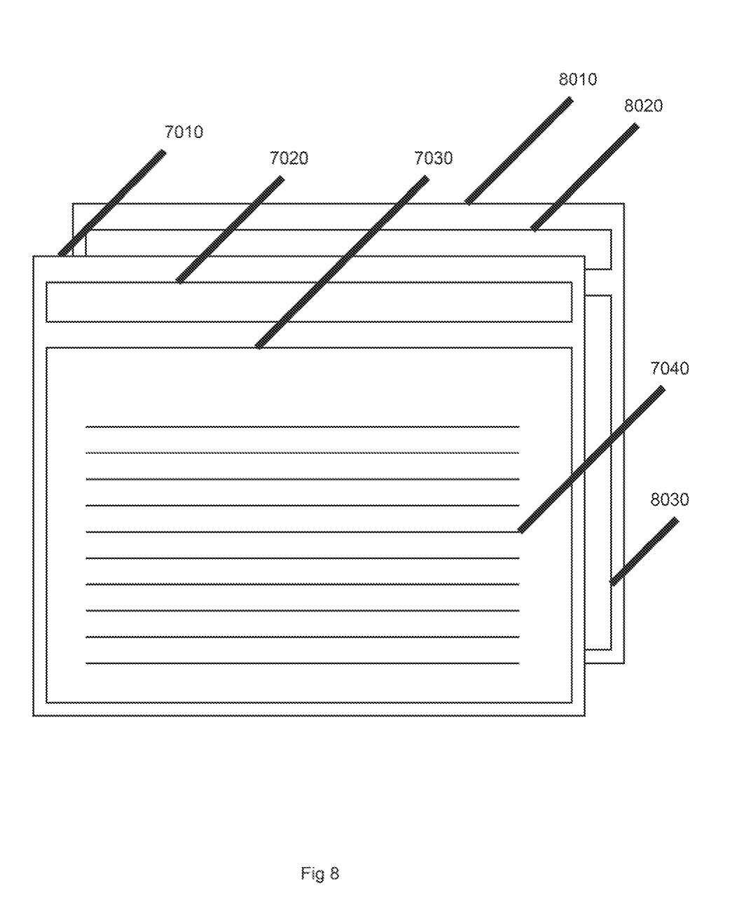

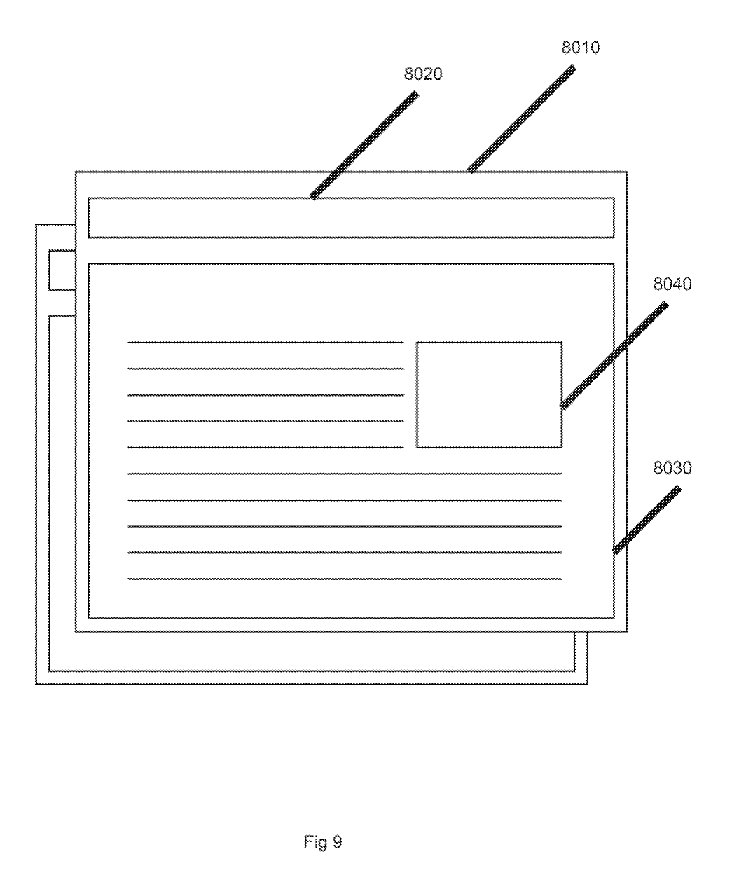

Another embodiment is described in FIG. 7, FIG. 8, and FIG. 9. FIG. 7 shows a web-browser window 7010 with a URL address bar 7020 and a viewport 7030 that is displaying a web-page 7040. Suppose the user were to open a new web-browser window behind the current foreground window. As shown in FIG. 8, the first window 7010 is in the foreground. A second window 8010 with an address bar 8020 and viewport 8030 is in the back. The second window contains an animated advertisement that is not visible at this point. Next, the user switches to the second window. Window 8010 comes to the foreground as described in FIG. 9. An advertisement 8040 that had been hidden earlier is now visible.

When the animated advertisement 8040 becomes visible, the animation is played from the beginning.

Instead of web-browser windows that display advertisements, we can have application windows that display advertisements. Instead of tabbed panels, we can use other GUI controls to change panels that are visible. Instead of scrolling through a web-page to see an advertisement at the bottom, we can scroll through any kind of document to reveal a previously hidden advertisement.

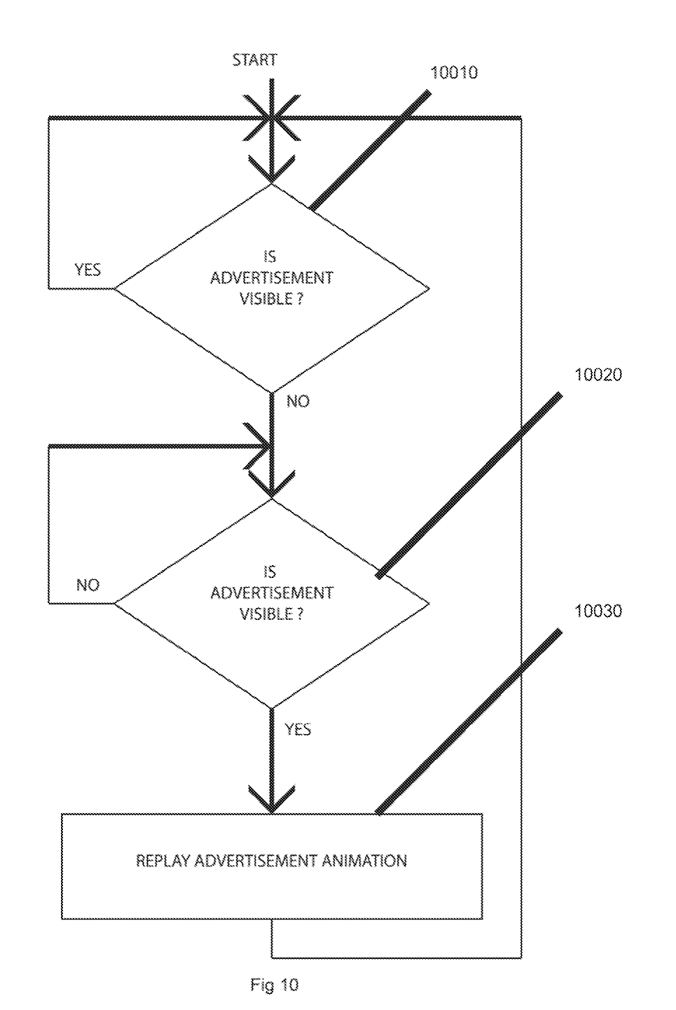

According to another embodiment described in FIG. 10, a process for improving performance of animated advertisements comprises the steps of waiting for an advertisement to become hidden 10010, waiting for the advertisement to become visible 10020, and playing the animation from the beginning 10030. Note that when we play an animation from the beginning, we might be interrupting a previously running animation and restarting the animation from the beginning. The question of whether the animation was already playing during the period when the advertisement was hidden is immaterial. When the advertisement was hidden, no one could see the animation, so it doesn't matter whether the animation was playing or not. But when the advertisement becomes visible, the animation is to start playing from the beginning so that the user gets a chance to see the entire animation until it finishes.

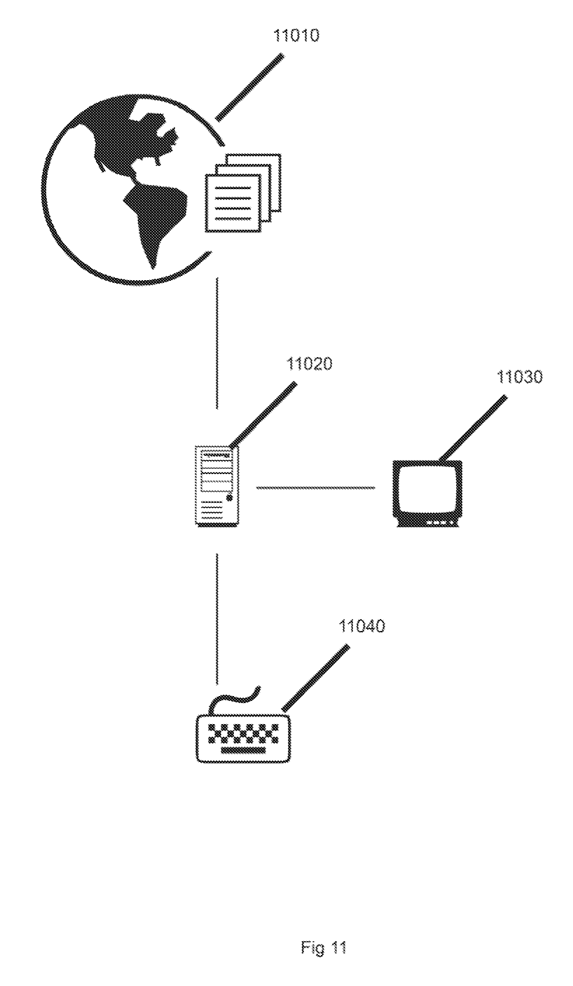

According to another embodiment, a computerized system for increasing the performance of advertisements is illustrated in FIG. 11. The system comprises a computation means 11020 that can access a source of animated advertisements such as the world-wide-web 11010. It further comprises a display means 11030 that can display advertisements within windows, tabs, documents, or other GUI elements so that the advertisement can become hidden and then again visible as the GUI elements change their state. It further comprises an Input/Output means 11040 through which a user can interact with the system.

The computation means comprises a logic means to detect when an animated advertisement is hidden, when the advertisement is visible within the display means, and a means to replay the animation.

In the embodiments discussed previously, instead of configuring the advertisement to play the animation immediately upon loading, we can configure the animation to play only when the advertisement becomes visible to the user. Such a configuration can be implemented within the media-player plugin. For example the Adobe Flash player can have logic included within it so that it checks to see if the advertisement is visible before it begins playing the animation. If the advertisement is not visible when the page first loads, the animation will be frozen until the advertisement becomes visible.

In the embodiments discussed so far we have talked about replaying the animation of an advertisement that is completely hidden and then becomes completely visible to the user. But often an advertisement might be partially hidden and then become less hidden. For example, an advertisement might be partially visible at the bottom of the web-browser window. If the user scrolls down a little more, the advertisement moves up within the window and becomes fully visible. Alternatively, if the user scrolls down just a little, the advertisement might remain partially hidden, but a little more of it may become visible.

When an animation plays while an advertisement is partially hidden, the advertiser's message might not reach the user properly. So there is value in replaying the animation of an advertisement which changes from being fully or partially hidden to being partially or fully visible. That is, when an advertisement becomes more visible than it was earlier, then replaying the animation will help the advertisement engage more with readers.

### Steps for Replaying Animations

How is an animated advertisement to be replayed? One way is to wait until the advertisement media has been loaded into the web-browser's cache. [The web-browsers window.onload event fires in javascript after everything on the page including the advertisement has loaded.] After the media is available in the cache, loading the media again will result in the media being loaded from cache instead of over the network. When media is loaded from the cache, it will appear instantaneously. So an advertisement can be replayed by reloading it from the cache. This method works well for advertisements that are animated using Adobe's Flash technology.

The steps are as follows:

Wait until the entire page including the advertisement has completed loading

Wait until the advertisement is hidden

Wait until the advertisement becomes visible to the user

Reload the advertisement media

How is the advertisement media to be reloaded? One way is to use the javascript DOM's cloning capability. Cloning an advertisement's media object in the browser creates an exact copy of the media object. The new media object will load instantly from the cache and begin playing. When the clone is ready, the original media is destroyed or hidden. This will make it appear as though the animation is being replayed.

Another way to replay animations is to have support for replaying built into the media itself. In the case of Flash, it might accept a call from javascript requesting the animation to replay. Similarly HTML5 animations can expose an API allowing javascript calls that replay the animation. Video advertisements can similarly expose APIs to restart the movie from the beginning.

Another way to replay animations is to wait until the media is fully loaded in the browser cache, delete the original flash object using javascript DOM functions, create a new flash object using javascript so that the source url of the new object is that same as the original, and place the new object in exactly the same location where the original object had been located. The new object has the same source url as the original, so it will be loaded instantly from the cache. Once loaded, it will begin playing the animation. So to the viewer it appears as though the original media has been replayed from the beginning.

Other techniques for reloading the media include setting the source attribute of the flash/media object so that it loads the animation again from the cache, changing the innerHTML attribute of an object so that everything inside is loaded afresh, and so on.

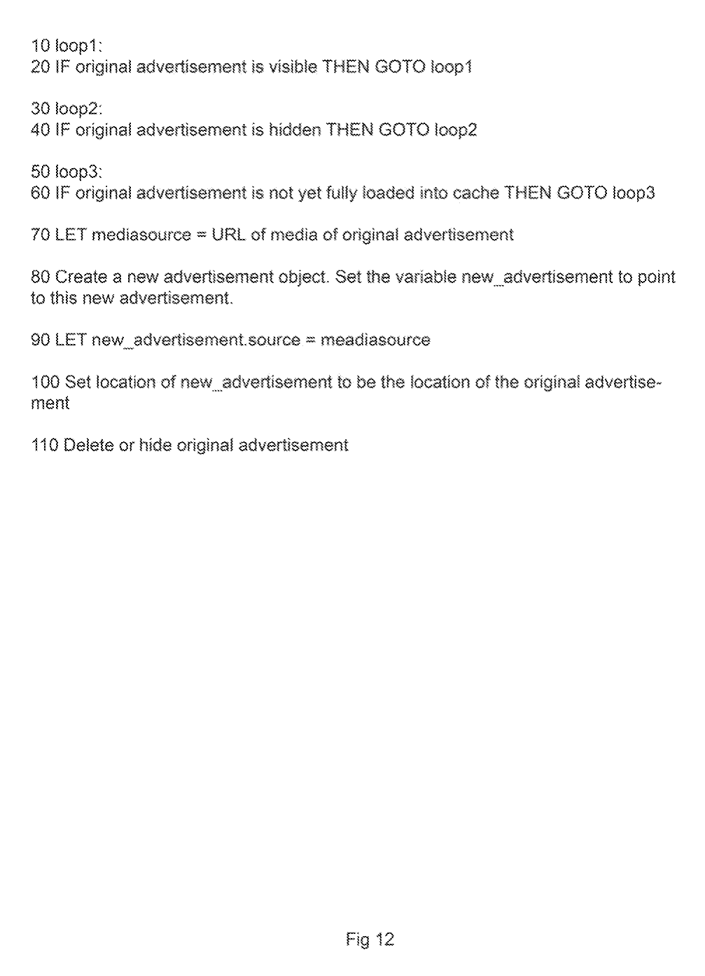

FIG. 12 illustrates an embodiment where the animation is replayed by creating a new advertisement object to replace the original. Lines 10, 20, 30, and 40 wait for the hidden advertisement to become visible. Lines 50 and 60 ensure that the advertisement media is in the web-browser's cache. Line 70 sets the variable mediasource to be the URL of the media file of the advertisement. The contents of this media file are already in the cache and if the web-browser requests this URL again, it will be loaded from the cache instead of going out over the network. Line 80 creates a new advertisement object. When created it has no media associated with it. In line 90 we set the media of the new advertisement object to point to mediasource. This will cause the new advertisement to load the same media as the original advertisement. The media will be loaded instantly from the cache and the animation will begin playing. In line 100 we place the new advertisement exactly where the original advertisement was located. Next, in line 110 we hide or delete the original advertisement. Because we are placing the new advertisement exactly where the original was located, and the new advertisement loads from cache and begins playing immediately, it appears as though the original advertisement's animation has been replayed.

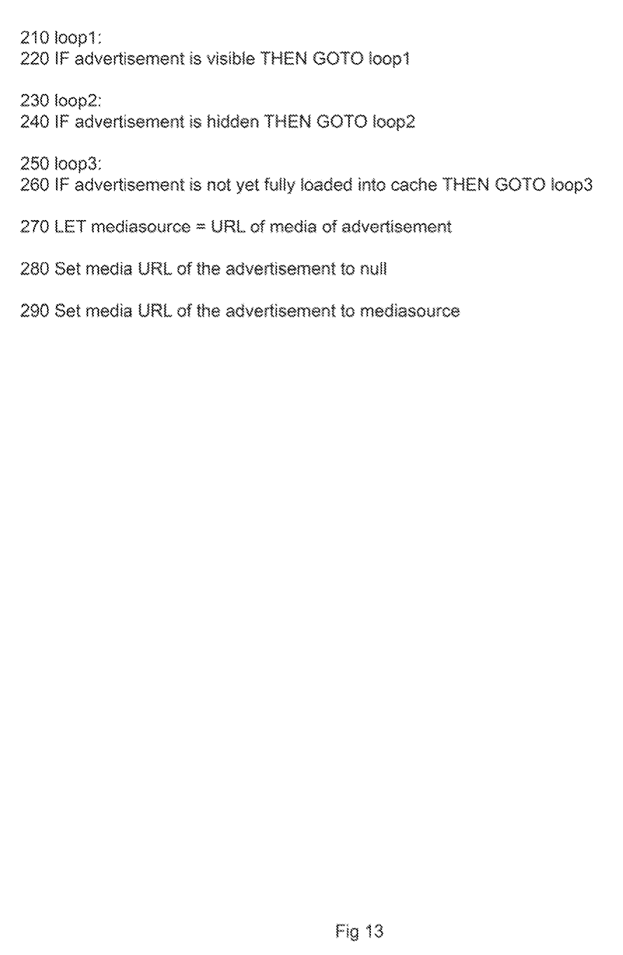

FIG. 13 illustrates an embodiment where the advertisement's media is reloaded. In lines 210 to 260 we wait for the advertisement to be loaded into the cache and for it to become visible to the user. In line 270 we capture the URL of the advertisement media and store it in a variable called mediasource. In line 280 we clear the media within the advertisement. In line 290 we restore the original value of the advertisement's media URL. In many kinds of media objects this will cause the media to be loaded instantly from the cache and the animation will begin playing from the beginning.

### ADVANTAGES

From the description above, a number of advantages of some embodiments become evident:

Users see the advertisement animation from the beginning—as the advertiser intended. So users are exposed to the full message that the advertiser wishes to deliver.

Many animated advertisements stop their animations after some time—usually around 30 seconds. Replaying animations when advertisements become visible increase the likelihood that the animation is playing when the user's eyes are looking at the advertisement. This attracts the user's attention and gets better engagement. This leads to better response from users.

Often an advertisement becomes visible because of some user action—such as scrolling, changing tabs, activating/closing different applications, or changing windows. When the user is performing such actions, the user is not at that moment engrossed in reading content. So he/she is more open to viewing a brand's message in an advertisement. Playing an advertisement's animation at this time has a high likelihood to engage the user.

### CONCLUSION, RAMIFICATIONS AND SCOPE

Accordingly the reader will see that this process improves the earnings of a web-site publisher by:

Increasing the click-through-rates of advertisements

Ensuring that users see an advertisement's animation from the beginning

Increasing user engagement by playing advertisement animations when users are not engrossed in reading content, thereby increasing engagement.

Advertisements are replayed when they become visible to the user on any kind of display. Some possible displays are computer screen, cellular telephone screen, kiosk display, music player screen, information panels in cars, television screen, e-book readers, and projection displays.

Advertisements may be any kind of interactive software including documents, application windows, web-pages, and videos.

Animation can be through any technology including Adobe Flash, HTML5, javascript DOM animation, vector drawing systems, Java plugins, and animated image formats.

Although the description above contains many specifics, these should not be construed as limiting the scope of the embodiments but as merely providing illustrations of some of several embodiments. For example, instead of a web-page, any kind of interactive document can be used; instead of a browser, any kind of viewport that displays a portion of the document can be used; the document can be in an application on a mobile device that is displaying scrollable data within the application; and so on.

Thus the scope of the embodiments should be determined by the appended claims and their legal equivalents, rather than by the examples given.

### SOURCE CODE

Rename the source files provided as follows:

index_html.txt to index.html
relonaspace_clear_js.txt to relonaspace_clear.js
swfobject_js.txt to swfobject.js

Create a new flash file with an animation that runs for 30 seconds. The flash media should be compatible with Adobe Flash 10. The size should be 300 pixels width and 600 pixels height. The file should be called adreplayerdemo.swf.

Place all the files in the same directory of a Windows 7 computer and open the file called index.html in a web-browser. The screen size should be 1366×768. The computer should have at least 2 GB of RAM. The Adobe flash plugin should be of version 10. The web-browser should be Firefox 3.6, Firefox 4, Firefox 5, Chrome 13, Internet Explorer 8, Internet Explorer 9, or Safari 5. Alternatively, the files may be placed on a web-server and accessed from there over a network.

The invention claimed is:

1. A process of playing an animation in an advertisement in a viewport of a data processing system comprising
Waiting for said advertisement to become visible in said viewport,
Playing said animation from the beginning immediately after said advertisement becomes visible
Whereby said advertisement performs better.

2. The process of claim 1 where the step of playing said animation from the beginning comprises the steps of waiting for said advertisement to be completely loaded into a cache and reloading said advertisement from said cache.

3. The process of claim 1 where the step of playing said animation from the beginning comprises the steps of waiting for said advertisement to be completely loaded into a cache, creating a new advertisement object that loads the same media as the original advertisement from said cache, deleting or hiding the original advertisement, and displaying said new advertisement object in place of the original advertisement.
